(19) United States
(12) Patent Application Publication
(10) Pub. No.: US 2026/0321960 A1
(43) Pub. Date: Oct. 15, 2026

(54) RADIO COMMUNICATION DEVICE FOR VERTICALLY STACKED OBJECTS

(71) Applicant: COMPAGNIE GENERALE DES ETABLISSEMENTS MICHELIN, Clermont-Ferrand (FR)

(72) Inventors: JULIEN DESTRAVES, Clermont-Ferrand (FR); PIERRE GUINAULT, Clermont-Ferrand (FR); LIONEL MEYER, Clermont-Ferrand (FR)

(21) Appl. No.: 18/998,842

(22) PCT Filed: Jul. 25, 2023
(86) PCT No.: PCT/EP2023/070637

§ 371 Date: Jan. 27, 2025

(30) Foreign Application Priority Data
Jul. 28, 2022 (FR) FR2207779

(51) Int. Cl. H01Q 1/22; G06K 7/10; G06K 17/00; H01Q 19/17

(52) U.S. Cl. CPC H01Q 1/2241; G06K 7/10118; G06K 7/10356; H01Q 1/2216; H01Q 19/17; G06K 7/10445; G06K 17/0029

(57) ABSTRACT

The invention relates to a radiofrequency communication device comprising:
a base the normal of which defines a vertical direction,
a radiofrequency communication reader,
a first arm the main dimension of which extends along a first direction,
the first arm comprising at least two radiofrequency antennas arranged along the first direction,
   characterized in that the device comprises a system for rotation about an axis of rotation collinear with the vertical direction, in that each of the radiofrequency antennas is connected to a port of the radiofrequency communication reader, in that the at least two radiofrequency antennas have a polarization with an electric field E the radial component of which is less than one quarter of the norm of the electric field E, and in that the first arm is positioned radially outside the axis of rotation.

### FIELD OF THE INVENTION

The present invention relates to the field of the logistical management of connected or connectable assets, and particularly to assets of the tyre casing type, whether the tyre casing is mounted on a rim or not.

### TECHNOLOGICAL BACKGROUND

The development of electronic objects in material or physical assets such as tyre casings makes it possible to make said assets connectable and connected, which stimulates the development of new services in order to optimize the use or identification of the physical asset for example. The emergence of this digital functionality leads to the rethinking of certain operations, in particular operations for managing physical assets in order to pool actions at times when the physical assets are little-used or the electronic objects contained in said physical assets are available or little-used. For operations for digitally identifying the physical asset when stacked or for checking the compliance of the stack of physical assets, all of the physical assets to be communicated with must be rendered readable to ensure the reliability of the information exchanged therewith, without this being a hindrance with respect to the forming of said physical assets. Changing the forming of the physical assets would result in downtime of the physical assets, which is detrimental to the productivity linked to said physical asset, such as extending the transport time and the non-use of the physical asset during this step. Although they are able to communicate, the devices of these physical assets are generally silent in order to conserve their own power source or because they do not have a power source.

It is thus necessary to initiate the communication of the communicating devices of these physical assets in particular to supply them with power so that they can respond, or perform checks on the suitability of the information transmitted by the communicating device with respect to the purpose of the stack of physical assets. All of these operations are time-consuming and are therefore detrimental to the productivity of these physical assets provided with a communicating device. Generally, the device communicates by radiofrequency wave and comprises a transponder that is capable of capturing the radiofrequency signal transmitted, interpreting it and performing an action in response to this signal that can for example be the transmission of another radiofrequency signal.

During the logistical steps, the physical assets are present in large numbers and the means for handling the assets are often made from metal, which is detrimental to the radiofrequency communication of the communicating devices. In order to overcome this difficulty in communication, the physical asset must be positioned so that the communicating device is oriented so that it is away from the metal areas. These operations are time-consuming, as they require manipulation of the physical assets on the conveyor line or off the conveyor, which is detrimental to the productivity of the physical assets conveyed by the conveyor line. The other solution consists in increasing the radiofrequency communication power, which can give rise to unsolicited interrogation of some physical assets situated near the target physical asset, which leads to a higher scrap rate of the physical assets, which is also detrimental to reducing the production cost of the physical asset.

The subject matter of the invention set out below aims to improve the quality of the radiofrequency communication of a plurality of physical assets that are vertically stacked, in order to reduce the production cost linked to the use of said physical asset while ensuring robust and reliable radiofrequency communication between said physical assets and external systems. Everything takes place in the context of the flow of the stacks of physical assets without changing the stacks if they are as expected. The first aim is to read all of the identifiers in the stack. The second aim is to be able to identify the order of the identifiers in the stack, or even the direction of placement of the object in the stack when the electronic device of the object is arranged on one side or the other of the object depending on the direction of the object corresponding to the direction of the stack.

### DESCRIPTION OF THE INVENTION

The invention relates to a radiofrequency communication device suitable for communicating with a radiofrequency transponder having a linearly polarized antenna, linked to a geometrically stable object, said device being suitable for receiving at least two of said objects placed vertically next to each other so as to form a stack that is circumscribed by a cylinder, and the polarization of the radiofrequency transponder of the geometrically stable object mainly being oriented in a circumferential direction relative to the axis of revolution of the cylinder circumscribing the stack of the at least two objects, said device comprising:
a base, suitable for receiving the stack of objects, the normal of which defines a vertical direction,
at least one radiofrequency communication reader suitable for generating or reading electrical signals to or from a radiofrequency antenna,
at least one first arm the main dimension of which extends along a first direction, the first direction preferably being collinear with the vertical direction,
the at least one first arm comprising at least two radiofrequency antennas spaced apart from each other along the first direction.
   The device is characterized in that the device comprises a system for rotation about an axis of rotation collinear with the vertical direction suitable for rotating part of the base suitable for receiving the stack of vertically arranged objects relative to the at least one first arm, in that each of said at least two radiofrequency antennas is connected to a single port of the at least one radiofrequency communication reader, in that the at least two radiofrequency antennas are elliptically polarized, preferably linearly polarized, with an electric field E the radial component of which is less than one quarter of the norm of the electric field E and the circumferential component of which is greater than 0.7 times the norm of the electric field E in the cylindrical coordinate system associated with the axis of rotation of the rotation system, in that two radiofrequency antennas that are contiguous along the first direction forming a pair of antennas, each pair containing the radiofrequency antennas that are situated on either side of the at least one first arm, in that the antennas situated on the same side of the at least one first arm are separated by a distance d′ along the first direction and in that the arm is positioned radially on the outside relative to the axis of rotation of the rotation system, suitable for being presented outside the cylinder circumscribing the stack of objects received by the device.

The physical assets can be provided with communication devices within their structure or on their surface. If the physical assets are axisymmetric about an axis of revolution, even if the angular position of the communication device within the physical asset can be defined, the assets are stacked without being angularly positioned with respect to each other in order not to waste cycle time to this end. The axisymmetry of the physical asset tends to make the azimuthal positioning of the physical assets with respect to each other insignificant.

In this case, the performance of an angular scan between the stacked physical assets and the first arm by the rotation system ensures that all of the transponders of the physical assets are read. The rotation system can consist in rotating the stack of objects alone, or the first arm alone, or rotating the two objects differently, for example with a different rotation direction or different rotation speeds. Provided that each geographical area of the physical assets is observed for the same time period during the reading phase, the reading of all of the radiofrequency transponders associated with all of the stacked physical assets is evenly performed.

Necessarily, in order to differentiate between the vertical position of the radiofrequency transponders, at least two radiofrequency antennas that are vertically spaced apart from each other must be provided in order to communicate with different areas of the stack. Only the radiofrequency transponders present in that area of the stack will thus communicate with the radiofrequency antenna associated with the area. In order to divide the stack of physical assets into various areas, the antennas are spaced apart from each other along the direction of the stack. The method can initiate the transmitting and receiving of the radiofrequency waves on all of the antenna. By having multiple radiofrequency antennas and alternating those that communicate with said radiofrequency transponders of the assets, it is possible to both read all of the transponders and establish a relative vertical position of the transponders with respect to each other. Connecting each of the radiofrequency antennas to a single port of the at least one radiofrequency communication reader makes it possible for the communication between the radiofrequency antennas of the communication device and the radiofrequency transponders of the physical assets not to be sequential, which makes it possible to save communication time between the communication device and the stack of objects. Finally, the contiguous radiofrequency antennas are situated on either side of the first arm, which ensures that the radiation patterns of the two antennas only overlap a little or not at all. What is needed is for two antennas situated on the same side of the first arm to be spaced apart from each other by a distance d′ along the first direction so that their radiation patterns do not interfere with each other. A communication area of the stack can thus be created using a plurality of antennas optionally positioned at different heights, preferably half way along the height of the distance d′.

This second function determines satisfactory ordering of the physical assets in the stack.

The radiofrequency transponders of the physical assets have a linearly polarized antenna that is mainly oriented in a circumferential direction relative to the axis of revolution of the cylinder circumscribing the stack, that is, the electric field E of the antenna has a radial component in the cylindrical coordinate system associated with the axis of rotation of the rotation system the amplitude of which is less than one quarter of the norm of the electric field E. In order to ensure effective communication between the radiofrequency transponders of the physical assets and the radiofrequency antennas of the device, the polarization axis of the radiofrequency antennas of the device must be made collinear with the polarization axes of the radiofrequency transponders of the physical assets. To this end, the polarization axis of the radiofrequency antennas is mainly oriented circumferentially relative to the axis of rotation of the stack by constraining the components of the electric field E of each radiofrequency antenna relative to the axis of rotation of the rotation system. The distinctive feature with respect to the component of the electric field generated by the radiofrequency antenna of the device according to the invention in the cylindrical coordinate system ensures that the circumferential component of the electric field E is at least equal to 0.7 times the norm of the electric field E generated by the radiofrequency antenna in transmission. In addition, the radial component of the electric field E is the smallest component in amplitude. The polarization axis of the radiofrequency antenna of the device is thus substantially collinear with the polarization axis of the transponder of the physical asset, which ensures high-quality radiofrequency communication. The communication energy of the device is thus optimized to communicate with the transponders of the physical assets due to the collinearity between the axis of the linear antenna and the electric field E, which ensures improved communication between the antennas, which makes it possible to apply a higher relative rotation speed between the stack of physical assets and the arm provided with the antennas, while retaining high-quality communication. To this end, the radiofrequency antenna of the device is elliptically polarized, preferably linearly polarized provided that the circumferential component is the greatest. The polarization of the antenna, which is its adaptation to the electric field in order to optimize the energy exchanged between the antenna and the electric field, must not be confused with the directivity of the antenna, which makes it possible to concentrate the energy on a spatial area around the antenna.

Advantageously, the communication device comprises a system for positioning the at least one first arm relative to the axis of rotation of the rotation system defining a trajectory of the at least one first arm.

The communication device can thus adapt regardless of the diameter of the cylinder circumscribing the stacked physical assets while ensuring an acceptable distance between the radiofrequency transponders of the physical assets rotated about the axis of rotation of the rotation system and the radiofrequency antennas of the communication device. However, the communication device can also adapt regardless of the angle of the cone of the stack of physical assets by means of an inclination between the first direction of the arm and the vertical direction of the base, while ensuring a similar distance between the radiofrequency transponders of the physical assets forming the cone and the radiofrequency antennas of the communication device. The trajectory followed by the arm so that it is positioned relative to the stack can be for example a translation, a rotation about an axis, or the combination of a translation and a rotation about an axis.

Preferably, the system for positioning the at least one first arm comprises a system for guiding the translation of the at least one first arm along a translation direction, the translation direction preferably intersecting the axis of rotation of the rotation system.

The most elementary of the movements of the first arm is a translation along a single direction. Preferably, this direction intercepts the axis of rotation of the rotation system, which durably ensures that the polarization axis of the radiofrequency antennas of the device remains mostly circumferential relative to the axis of rotation of the rotation system.

According to another embodiment, the device comprises an actuating system suitable for moving the at least one first arm relative to the trajectory imposed by the positioning system.

This makes it possible to automate the positioning of the first arm relative to the stack of physical assets without human intervention.

Advantageously, the communication device comprises a limiter, preferably comprising a sensor, suitable for stopping the movement of the first arm along the trajectory imposed by the positioning system when a threshold has been reached.

With the aim of automating the device and in order not to damage the stacked physical assets, the device comprises a limiter suitable for stopping the movement of the first arm on the trajectory imposed by the positioning system. The limiter, which can be provided with a sensor or comprises an open loop, evaluates the proximity of the first arm to the stacked physical assets by means of a value. This sensor can be a load cell that measures the contact force between the arm and the physical assets, or a proximity sensor that evaluates the distance between the arm and the outer surface of the vertical stack. However, in the case of an open loop, a pneumatic or hydraulic or electrical or magnetic setpoint can be used.

According to one embodiment, the communication device comprises a system for centring relative to the axis of rotation of the rotation system.

Preferably, the centring system comprises at least one vertical second arm radially connected to at least one first arm relative to the axis of rotation of the rotation system.

It is preferable for the stack of physical assets and/or the first arm to be positioned relative to the axis of rotation of the rotation system. The first arm is thus positioned with respect to the stack in an angular position relative to the axis of rotation that allows angular scans at a higher speed of the stack of physical assets or of the first arm. This centring system can consist of a series of vertical arms particularly comprising the first arm, the concentric movement of which is uniform relative to the axis of rotation. The concentric movement of the arms thus tends to position the stack of physical assets so that the axis of revolution of the cylinder circumscribing the stack coincides with the axis of rotation of the rotation system. To achieve this, the second arm must simply extend vertically at least on the physical asset situated at one of the ends of the stack. Generally, the physical asset situated in the vicinity of the base has the largest radial dimension to ensure the stability of the vertical stack, and the second arm is situated in the vicinity of the base in this case. This arm system is able to move the stack of physical assets on the base.

Preferably, the rotation system is incorporated into the base of the communication device.

This is a compact embodiment in which the rotation system comes out of the base to rotate the stack of physical assets and/or the first arm, by raising them off the base, for example. Once the rotation is complete, it disappears under the base in order to allow the handling of the stack of physical assets. One alternative would be for the rotation system to be situated vertically above the stack, which requires a specific part that is connected to the stack but does not form part of the stack.

According to one particular embodiment, the communication device comprises displacement means incorporated into the base, defining a trajectory passing through the axis of rotation of the rotation system, suitable for displacing the stack of physical assets received by the device along the trajectory.

These displacement means make it possible to handle the stack of physical assets on the base. They can be a roller belt for example. In addition, they also make it possible to centre the stack of physical assets relative to the axis of rotation of the rotation system, facilitating the movement of the stack along the trajectory defined because the trajectory intercepts the axis of rotation.

Advantageously, the at least one first arm comprises a reflective element situated radially outside said at least one first arm relative to the axis of rotation of the rotation system.

This reflective element, that is, which reflects the electromagnetic waves, makes it possible to interrogate the radiofrequency transponders of the physical assets situated in the stack and not outside the stack. This minimizes the risk of erroneous interrogation of radiofrequency transponders of physical assets situated in another stack or associated with the environment in which the communication device is placed.

Very advantageously, the reflective element is arranged radially outside at least the two radiofrequency antennas by a distance e, the distance e preferably being less than 0.5 times the wavelength linked to the frequency of the device. Here, distance between two components is given to mean the projection normal to the reflective element.

In order to benefit from an inflow of power radiated toward the stack, the reflective element must be positioned appropriately relative to the radiofrequency antennas of the communication device, which are the source of the electromagnetic waves. Adhering to the proximity mentioned between the reflective element and the radiofrequency antennas substantially increases the communication capacity of the communication device by increasing the radiated power transmitted toward the stack of physical assets. For passive radiofrequency transponders such as RFID (Radio Frequency IDentification) tags, the greater the power transmitted, the more effective the radiofrequency communication.

According to one specific embodiment, the communication device comprises at least one other first arm positioned in an identical radial position and a different azimuthal position with respect to the at least one first arm relative to the axis of rotation of the rotation system, the first arms being preferably evenly distributed about the axis of rotation.

Having multiple first arms increases the number of communication antennas. Positioning the different arms in different azimuthal positions but in the same radial position relative to the axis of rotation of the rotation system makes it possible to interrogate all of the radiofrequency transponders of the stack of physical assets in a minimum number of rotations of the stack of physical assets or to read the radiofrequency transponders of the stack multiple times in a minimum number of rotations of the stack. Preferably, if the first arms are evenly distributed around the stack, an angular fraction separating two contiguous first arms is sufficient for reliable, effective and fast interrogation of the entire stack of physical assets.

According to another specific embodiment, each at least one other first arm comprises at least two radiofrequency antennas, the two radiofrequency antennas of each at least one other first arm being situated at different heights with respect to the heights of the at least two radiofrequency antennas of the at least one first arm.

In this configuration, the improvement of the speed of reading the radiofrequency transponders of the stack is not systematically sought. What is however sought is an increase in the spatial differentiation, in particular in the vertical direction, between the radiofrequency transponders of the stack. The pitch between the radiofrequency antennas is increased in the vertical direction without having to manage the radiofrequency disturbance between vertically close antennas due to an azimuthal distribution of the antennas around the stack.

According to another particular embodiment, the communication device comprises two first arms situated diametrically opposite each other relative to the axis of rotation of the rotation system.

This is a balanced configuration in terms of number of first arms, making it possible to perform one half-turn of the stack to interrogate all of the radiofrequency transponders of the stack with sufficient differentiation in the vertical direction for tyre casings for example.

Preferably, each radiofrequency antenna defines, depending on the electrical power supplied, a communication area characterized by a gain defining the maximum distance Di from the communication area and a beam angle αi, the distance d′ along the first direction separating two radiofrequency antennas situated on the same side of the at least one first arm is less than the threshold A defined by the following formula:

$$A = {\sum }_{i} {D}_{i} * cos ( {α}_{i} ) \qquad [ Math 1 ]$$

This ensures that no electromagnetic radiation white spot appears between two antennas that are contiguous along the first direction and on the same side of the first arm on the stack. One of the possible levers for ensuring the geographical coverage of the antennas is to adjust the electrical power supplied to the radiofrequency antenna within the bounds of the standards in force. Providing the first arm with sufficient radiofrequency antennas to cover a height greater than the highest height of a stack of physical assets ensures that the communication device covers the interrogation and reading of any stack of physical assets. This ensures that all of the radiofrequency transponders of the physical assets of the stack are interrogated and listened to by the communication device.

Preferably, the at least two radiofrequency antennas are selected from the group consisting of a dipole antenna, a slot antenna, a loop antenna, and a patch antenna.

The first two antennas, dipole and slot, are linearly polarized antennas, the axis of the dipole antenna or the axis of the slot defining the polarization axis of the antenna. The next two, loop and patch, are circularly or elliptically polarized antennas. The plane of the antenna will be positioned in a plane the normal of which is substantially the radial direction of the cylindrical coordinate system associated with the axis of rotation of the rotation system. Optionally, the shape of the antenna can be determined in order to favor one direction of the two directions defining the plane of the antenna and thus obtain an elliptically polarized antenna that makes it possible to favor the circumferential direction of the cylindrical coordinate system associated with the axis of rotation of the rotation system rather than the radial direction.

The invention also relates to the use of the communication device with stacked objects selected from the group consisting of a tyre casing, a wheel, a wheel valve such as a TPMS (tyre pressure monitoring system) valve, and an elastomeric element of the mounted assembly.

These are physical assets that can be stacked for defining mounted assemblies of a passenger vehicle for example. The tyre casing can comprise an RFID (Radio Frequency IDentification) tag located in the sidewall of the tyre and oriented circumferentially relative to the natural axis of rotation of the tyre casing. The wheel and the valve of the mounted assembly can also be provided with radiofrequency transponders the communication antenna of which is oriented circumferentially relative to the natural axis of rotation of the wheel, which coincides with the axis of rotation of the tyre casing for a mounted assembly.

The invention also relates to a conveyor line suitable for conveying stacked objects along a given path comprising a communication device suitable for communicating with the radiofrequency transponders linked to these objects.

Preferably, the radiofrequency communication device is placed between two conveyors, the first conveyor, placed upstream on the given path, comprising a centring system suitable for positioning the stack of objects relative to the width of the radiofrequency communication device.

In the field of logistics, incorporating a radiofrequency communication device along the conveyor line makes it possible to monitor the stack of objects while the stack is being conveyed with minimal immobilization of the stack of objects, which ensures a competitive production cost. In the event that the stack is non-compliant, it also makes it possible to remove a non-compliant stack of objects from the stream by incorporating the radiofrequency communication device between two conveyors of the conveyor line: the function of identifying and ordering the products and optionally the direction of placement thereof is thus optimized. Centring the stack in the direction transverse to the trajectory defined by the radiofrequency communication device ensures that the stack is pre-arranged relative to the communication device. As a result, if the communication device is provided with integrated displacement means and centring means, centring the stack relative to the trajectory minimizes the centring of the stack in a direction perpendicular to the trajectory of the displacement means of the communication device. As a result, the centring means of the communication device consists in aligning the axis of revolution of the cylinder circumscribing the stack of physical assets with the axis of rotation of the rotation system contained in the communication device. The dimensions of this centring system are thus minimal, which reduces costs.

### BRIEF DESCRIPTION OF THE DRAWINGS

The invention will be better understood upon reading the following description, which is provided solely by way of a non-limiting example and with reference to the appended figures, in which the same reference numbers in all cases denote identical parts and in which:

FIG. 1 is a perspective view of a first radiofrequency communication device according to the invention,

FIG. 2 is a perspective view of a second radiofrequency communication device according to the invention,

FIG. 3 is a radiation pattern of a radiofrequency antenna,

FIG. 4 shows a stack of physical assets comprising tyre casings provided with RFID (Radio Frequency IDentification) tags,

FIG. 5 is a perspective view of a conveyor line comprising a radiofrequency communication device.

### DETAILED DESCRIPTION OF EMBODIMENTS

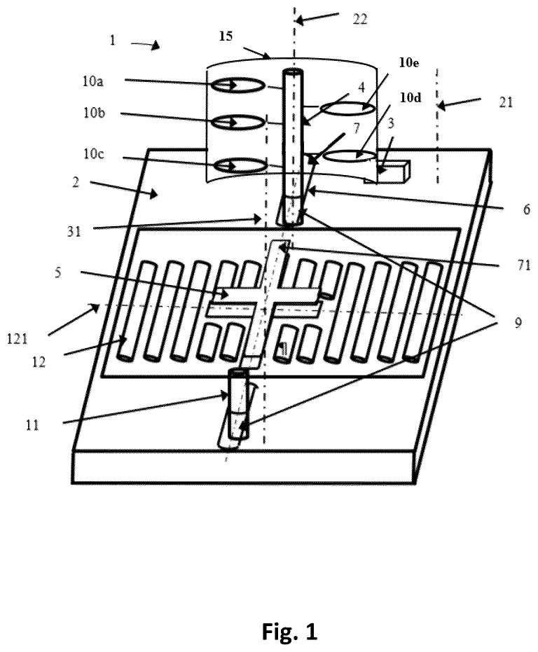

FIG. 1 shows a first radiofrequency communication device 1. Said device comprises a base 2 defining a vertical direction 21 along the normal to the outer surface of the base with respect to which the other elements of the radiofrequency device 1 are located and which corresponds to the surface in contact with the stack of physical assets. The device 1 also comprises a first arm 4 the main direction of which defines a first direction 22. This first direction 22 is collinear with the vertical direction 21.

The device 1 comprises a system 5 for rotating the stack of physical assets, here incorporated into the base 2 of the device 1, and shown by a cross that is rotated about an axis of rotation 31. This cross 5 is also translated in the vertical direction 21 so that it is situated below or above the fixed outer surface of the base 2 depending on the communication phase between the device 1 and the stack of physical assets. The stack of physical assets can thus be immobilized or translated relative to the fixed part of the base 2 of the device 1.

The first arm 4 is provided with radiofrequency antennas split into two groups situated on either side of the first arm 4. The first group comprises the antennas 10a, 10b, and 10c, and the second group comprises the radiofrequency antennas 10d and 10e. These radiofrequency antennas 10a, 10b, 10c, 10d, and 10e are galvanically connected to a radiofrequency reader 3. The radiofrequency reader 3 transmits and receives radiofrequency signals to or from the radiofrequency antennas. The radiofrequency antennas 10a, 10b, 10c, 10d, and 10e are physically connected to the radiofrequency reader 3 by means of ports on the radiofrequency reader 3, each of the antennas being connected to a single port. The radiofrequency antennas 10a, 10b, 10c and 10d, 10e of each group are separated from each other in pairs by a distance d′ so that the height of the stack of physical assets is covered by the radiofrequency radiation of the group of radiofrequency antennas. Conversely, in this configuration, the heights of the antennas of the two groups are different, which makes it possible to improve the differentiation between the radiofrequency transponders of the objects of the stack along the vertical direction 21. In this optimized configuration, the first arm 4 is provided with a reflective element 15 situated radially outside the radiofrequency antennas 10a, 10b, 10c, 10d, and 10e of the first arm 4. The distance e between the antennas 10a, 10b, 10c, 10d, and 10e and the reflective element is less than half of the wavelength associated with the communication frequency of the device 1. This reflective element 15 prevents radiofrequency radiation radially outside the reflective element 15 relative to the axis of rotation 31. In addition, the distance e between the reflective element 15 and the radiofrequency antennas 10a, 10b, 10c, 10d, and 10e ensures that the radiofrequency power radiated toward the stack of physical assets is improved. The antennas of the device are elliptically polarized, preferably linearly polarized, so that the main component of the transmission electric field is borne by the circumferential direction in the cylindrical coordinate system associated with the axis of rotation 31 of the rotation system 5.

Here, the stack of physical assets is translated relative to the device 1 by means 12 for displacing the stack. These displacement means 12, incorporated into the base 2, consist here of a series of rollers parallel to each other. Each roller is rotated about an axis, and here the axes are collinear. The trajectory 121 of the stack of physical assets is thus formed using the rollers. Here, this trajectory 121 passes through the axis of rotation 31 of the rotation system 5. These displacement means 12 make it easy to guide the stack of physical assets on the base 2 so as to position the stack of physical assets relative to the axis of rotation 31 of the rotation system 5 of the device 1. In this case, the rotation system 5 rises above the outer surface of the base 2 so that it carries the stack of physical assets and thus separates it from the outer surface of the base 2. The rotation system 5 then starts to rotate about its axis of rotation 31 in order to rotate the stack of physical assets.

In this configuration, the first arm 4 is guided in translation by a positioning system 6. Here, this positioning system 6 comprises a translation guiding system 7 consisting of a groove in the outer surface of the base 2. This groove 7 defines a translation direction 71 that passes through the axis of rotation 31 of the rotation system 5. This makes it possible to bring the first arm 4 closer with respect to the stack of physical assets regardless of the radial dimension of the stack of physical assets.

The first arm 4 is driven by means of an actuating system comprising an electric, pneumatic, or hydraulic power source and ensuring automated translation of the first arm 4 along the direction 71. Likewise, in order to automate the positioning of the first arm 4, the device 1 here comprises a limiter controlling the displacement of the first arm along the trajectory 7 depending on the proximity of the first arm 4 with respect to the stack of physical assets. This limiter thus comprises a sensor that determines the distance between the sensor and the stack of physical assets in order to stop the movement of the first arm 4 according to the measurement supplied by this sensor with respect to a threshold that represents the collision of the first arm 4 with the stack of physical assets. This sensor is an electromagnetic or optical proximity sensor or a contact sensor.

The translation guiding system 7 makes it possible to position the radiofrequency antennas 10a, 10b, 10c, 10d, and 10e of the first arm 4 uniquely so that the polarization direction of these antennas 10a, 10b, 10c, 10d, and 10e is mainly circumferential relative to the axis of rotation 31 of the rotation system 5. Here, the radiofrequency antennas 10a, 10b, 10c, 10d, and 10e are elliptically polarized loop antennas the main direction of which extends circumferentially relative to the axis of rotation 31.

Finally, the device 1 here comprises a centring system 9 that makes it possible to position the stack of physical assets appropriately relative to the rotation system 5, and more precisely to make the axis of revolution of the cylinder circumscribing the stack of physical assets coaxial with the axis of rotation 31 of the rotation system 5. This allows improved dynamic stability of the stack of physical assets, in particular at high rotation speed of the stack of physical assets, by balancing the centrifugal forces applied to the stack of physical assets over the whole periphery of the stack of physical assets. Here, the centring system 9 comprises the first arm 4 and a second arm 11. The two arms are connected to each other in order to ensure opposing translation so that the distance between each arm and the axis of rotation 31 of the rotation system is identical. To this end, the second arm 11 is translated along the same direction 71 as the first arm 4 by means of a groove made in the outer surface of the base 2.

In addition, this centring of the stack of physical assets ensures that the distance between the first arm 4 and any material point of the stack of physical assets situated at a height H of the stack along the vertical direction 21 is identical. As a result, the radiofrequency communication between the radiofrequency transponders of the physical assets and the radiofrequency antennas 10a, 10b, 10c, 10d, and 10e of the first arm 4 is even.

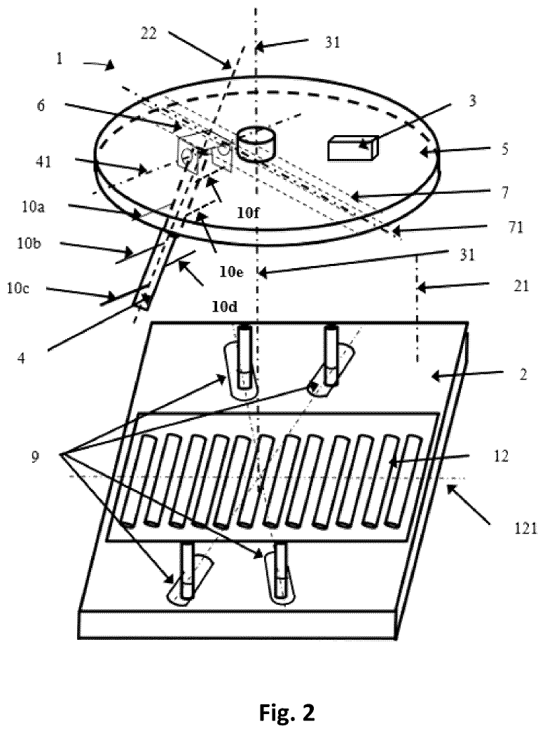

FIG. 2 shows a second radiofrequency communication device 1 according to the invention. This device 1 still comprises a base 2 suitable for holding the stack of physical assets. It also comprises a first arm 4 provided with radiofrequency antennas 10a, 10b, 10c, 10d, 10e, and 10f, which are connected by means of connecting ports to a radiofrequency reader 3. However, here, the first arm 4 extends mainly along a first direction 22 that is not necessarily collinear with the vertical direction 21 defined by the outer surface of the base 2, the surface for receiving the stack of physical assets.

The first arm 4 is provided with radiofrequency antennas split into two groups situated on either side of the first arm 4. The first group comprises the antennas 10a, 10b, and 10c, and the second group comprises the radiofrequency antennas 10d, 10e, and 10f. These radiofrequency antennas 10a, 10b, 10c, 10d, 10e, and 10f are galvanically connected to a radiofrequency reader 3. The radiofrequency reader 3 transmits and receives radiofrequency signals to or from the radiofrequency antennas. The radiofrequency antennas 10a, 10b, 10c, 10d, 10e, and 10f are physically connected to the radiofrequency reader 3 by means of ports on the radiofrequency reader 3, each of the antennas being connected to a single port. The radiofrequency antennas 10a, 10b, 10c, and 10d, 10e, and 10f of each group are separated from each other in pairs by a distance d′ so that the height of the stack of physical assets is covered by the radiofrequency radiation of the group of radiofrequency antennas. Conversely, in this configuration, the heights of the antennas of the two groups are different, which makes it possible to improve the differentiation between the radiofrequency transponders of the objects of the stack along the vertical direction 21.

The device 1 comprises a system 5 for rotation about an axis of rotation 31. However, the rotation system 5 drives the rotation of the first arm 4 instead of the rotation of the stack of physical assets as in FIG. 1.

The device 1 also comprises a system 6 for positioning the first arm 4 relative to the axis of rotation 31 of the rotation system 5. This positioning system 6 comprises a system 7 for guiding translation by means of a groove. This groove defines the trajectory of the first arm 4 along a translation direction 71. Here, the translation direction 71 intersects the axis of rotation 31 of the rotation system 5. The positioning system 6 also comprises a system for rotating the first arm 4 relative to the axis of rotation 41 in order to define the first direction 22 of the first arm 4.

The translation guiding system 7 makes it possible to position the radiofrequency antennas 10a, 10b, 10c, 10d, 10e, and 10f of the first arm 4 uniquely so that the polarization direction of these antennas 10a, 10b, 10c, 10d, 10e, and 10f is mainly circumferential relative to the axis of rotation 31 of the rotation system 5. Here, the radiofrequency antennas 10a, 10b, 10c, 10d, 10e, and 10f are linearly polarized half-wave dipole antennas the main direction of which extends circumferentially relative to the axis of rotation 31.

The movement of the first arm 4 by means of the positioning system 6 is automated by an actuating system. This actuating system controls both the rotation of the first arm 4 about the axis of rotation 41 and the translation of the first arm 4 along the translation direction 71 in order to ensure the proximity of the first arm 4 with respect to the stack of physical assets. In addition, the device 1 comprises a limiter that controls the driving of the first arm 4. This limiter thus comprises a sensor that determines the distance between the sensor and the stack of physical assets in order to stop the movement of the first arm 4 according to the measurement supplied by this sensor with respect to a threshold that represents the collision of the first arm 4 with the stack of physical assets. This sensor is an electromagnetic or optical proximity sensor or a contact sensor.

Here, the stack of physical assets is translated relative to the device 1 by means 12 for displacing the stack. These displacement means 12, incorporated into the base 2, consist here of a series of rollers parallel to each other, and could also be a slider bed. Each roller is rotated about an axis, and here the axes are collinear. The trajectory 121 of the stack of physical assets is thus formed using the rollers.

Here, this trajectory 121 passes through the axis of rotation 31 of the rotation system 5. These displacement means 12 make it easy to guide the stack of physical assets on the base 2 so as to position the stack of physical assets relative to the axis of rotation 31 of the rotation system 5 of the device 1.

Finally, the device 1 here comprises a centring system 9 that makes it possible to position the stack of physical assets appropriately relative to the rotation system 5, and more precisely to make the axis of revolution of the cylinder circumscribing the stack of physical assets coaxial with the axis of rotation 31 of the rotation system 5. Here, the centring system 9 comprises four of the second arms arranged evenly on either side of the means 12 for displacing the stack of physical assets. The four second arms are connected to each other in order to ensure a clamping movement about the axis of rotation 31 of the rotation system 5 so that the distance between each arm and the axis of rotation 31 of the rotation system 5 is identical. To this end, here the second arms are translated along two translation directions by means of grooves made in the outer surface of the base 2. The two translation directions intersect each other at the axis of rotation 31 of the rotation system 5.

In addition, this centring of the stack of physical assets ensures that the distance between the first arm 4 and any material point of the stack of physical assets situated at a height H of the stack along the vertical direction 21 is identical. As a result, the radiofrequency communication between the radiofrequency transponders of the physical assets and the radiofrequency antennas 10a, 10b, and 10c, 10d, 10e, and 10f of the first arm 4 is even.

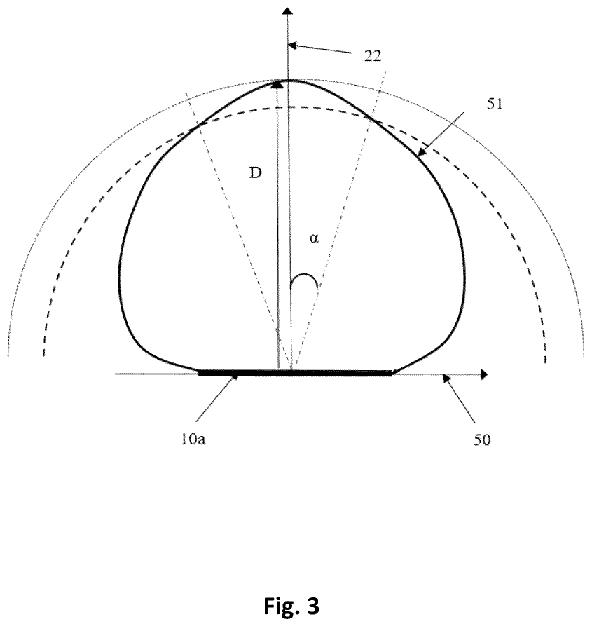

FIG. 3 illustrates the main radiofrequency radiation lobe 51 of the radiofrequency antenna 10a of the first arm of the radiofrequency communication device in a plane defined by the polarization axis 50 of the radiofrequency antenna 10a and the first direction 22 of the first arm. Here, the radiofrequency antenna 10a is a half-wave dipole antenna.

From the power supplied to the antenna, it radiates omnidirectionally so that the equal power curves show closed contours on both ends of the antenna 10a. FIG. 3 shows a radiofrequency radiation equal power curve 51. It is then possible to determine the distance D and the beam angle α associated with this radiofrequency antenna, which makes it possible to characterize the effective communication area of this antenna 10a. Here, the depiction is limited to a sub-space because the communication area of the dipole antenna is axisymmetric relative to the polarization axis 50 of the antenna.

An effective distance D′ is thus determined that corresponds to the product of cos a by the distance D of the equal power curve 51 that determines the distance at which at least half of the radiofrequency power is exchanged between the radiofrequency antenna 10a and a material point in space situated at the distance D′.

As the radiofrequency antennas are situated along the first direction of the first arm in groups, the spacing between two antennas that are contiguous along the first direction of each group, that is the antennas situated on the same side of the first arm, must be less than the sum of the distances D′ associated with the radiofrequency antennas.

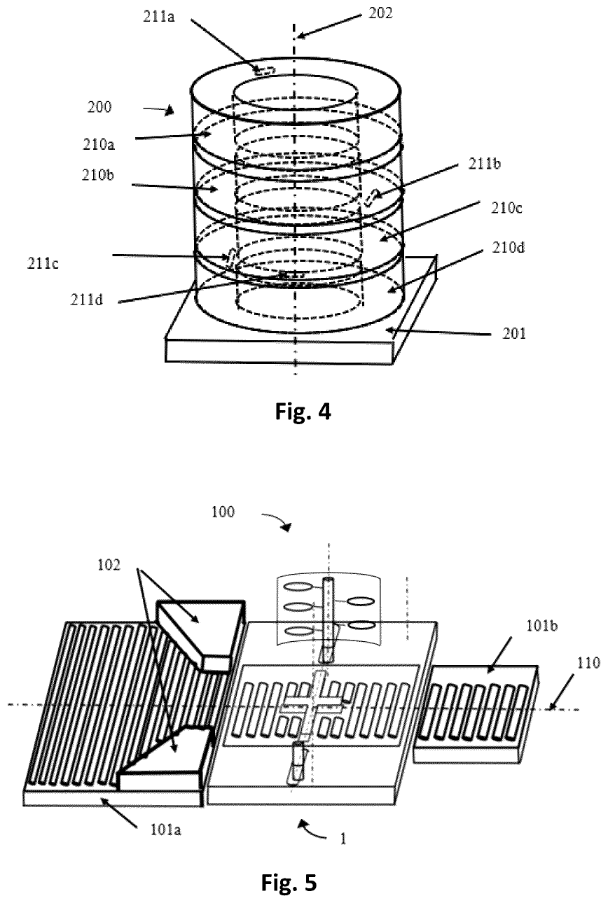

FIG. 4 shows a stack 200 of physical assets. Here, the physical assets are four mounted assemblies only the tyre casings 210a, 210b, 210c, and 210d of which are shown. The casings are stacked on each other along the direction defined by the axis 202. This stack 200 is therefore inscribed in a right cylinder having an axis 202, the diameter of which corresponds to the outermost diameter of the tyre casings 210a, 210b, 210c, and 210d.

Here, the stack 200 is placed on a base 201, facilitating the displacement of the stack 200. The base 201 is provided, on the opposite face thereof from the face in contact with the stack 200, with displacement means such as castors, for example, not shown in FIG. 4. The stack 200 can thus be positioned manually relative to a radiofrequency communication device and in particular the stack 200 can be positioned relative to the first arm and the axis of rotation of the rotation system of the radiofrequency communication device. In this case, the radiofrequency communication device does not necessarily need means for displacing the stack of physical assets.

Each tyre casing 210a, 210b, 201c, and 210d is provided with a radiofrequency transponder 211a, 211b, 211c, and 211d, which in this case is an RFID tag consisting of an electronic chip coupled to a half-wave dipole radiofrequency antenna, which is a linearly polarized antenna. The radiofrequency antenna extends along its main dimension circumferentially relative to the axis 202.

FIG. 5 shows a conveyor line 100 for stacked physical assets comprising a radiofrequency communication device 1. Here, the device 1 corresponds to the one shown in FIG. 1.

This conveyor line 100 defines a path 110 that the stacks of physical assets travel on from a starting point to an end point. Here, this path 110 extends over the three elements of the conveyor line 100, that is a first conveyor 101a situated upstream on the path 110, a second conveyor 101b situated downstream on the path 110, and the radiofrequency communication device 1 situated between the two conveyors 101a and 101b. Here, the two conveyors 101a and 101b are provided with drive rollers the main direction of which is perpendicular to the path 110. The first conveyor 101a comprises a centring system 102 in order to direct the stacks of physical assets toward the middle of the width of the conveyor 101a and thus prepare the stack of physical assets for passing in front of the radiofrequency communication device 1. As the radiofrequency communication device 1 is situated in the middle of the width of the first conveyor 101a, here, the centring system is provided with two lane narrowing elements 102 that are symmetrical with respect to the path 110.

1.-15. (canceled)

16. A radiofrequency communication device suitable for communicating with a radiofrequency transponder having a linearly polarized antenna, linked to a geometrically stable object, the radiofrequency communication device being suitable for receiving at least two of the objects placed vertically next to each other so as to form a stack that is circumscribed by a cylinder, and a polarization of the radiofrequency transponder of the geometrically stable object mainly being oriented in a circumferential direction relative to an axis of revolution of the cylinder circumscribing the stack of the at least two objects, the radiofrequency communication device comprising:
a base, suitable for receiving the stack of objects, a normal of which defines a vertical direction;
at least one radiofrequency communication reader suitable for generating or reading electrical signals to or from a radiofrequency antenna; and
at least one first arm, a main dimension of which extends along a first direction, the at least one first arm comprising at least two radiofrequency antennas spaced apart from each other along the first direction,
wherein the radiofrequency communication device comprises a system for rotation about an axis of rotation collinear with the vertical direction suitable for rotating part of the base suitable for receiving the stack of vertically arranged objects relative to the at least one first arm,
wherein each of the at least two radiofrequency antennas is connected to a single port of the at least one radiofrequency communication reader,
wherein the at least two radiofrequency antennas are elliptically polarized with an electric field E, a radial component of which is less than one quarter of a norm of the electric field E and a circumferential component of which is greater than 0.7 times a norm of the electric field E in a cylindrical coordinate system associated with the axis of rotation of the rotation system,
wherein two radiofrequency antennas that are contiguous along the first direction form a pair of antennas, each pair containing the radiofrequency antennas that are situated on either side of the at least one first arm,
wherein the radiofrequency antennas situated on a same side of the at least one first arm are separated by a distance d′ along the first direction, and
wherein the at least one first arm is positioned radially on an outside relative to the axis of rotation of the rotation system, suitable for being presented outside the cylinder circumscribing the stack of objects received by the radiofrequency communication device.

17. The radiofrequency communication device according to claim 16, wherein the first direction is collinear with the vertical direction.

18. The radiofrequency communication device according to claim 16, wherein the at least two radiofrequency antennas are linearly polarized.

19. The radiofrequency communication device according to claim 16, wherein the radiofrequency communication device further comprises a system for positioning the at least one first arm relative to the axis of rotation of the rotation system, defining a trajectory of the at least one first arm.

20. The radiofrequency communication device according to claim 19, wherein the system for positioning the at least one first arm comprises a system for guiding translation of the at least one first arm along a translation direction.

21. The radiofrequency communication device according to claim 20, wherein the translation direction intersects the axis of rotation of the rotation system.

22. The radiofrequency communication device according to claim 16, wherein the radiofrequency communication device further comprises a system for centering relative to the axis of rotation of the rotation system.

23. The radiofrequency communication device according to claim 22, wherein the centering system comprises at least one vertical second arm radially connected to at least one first arm relative to the axis of rotation of the rotation system.

24. The radiofrequency communication device according to claim 16, wherein the rotation system is incorporated into the base of the radiofrequency communication device.

25. The radiofrequency communication device according to claim 16, wherein the radiofrequency communication device further comprises displacement means incorporated into the base, defining a trajectory passing through the axis of rotation of the rotation system, suitable for displacing the stack of objects received by the radiofrequency communication device along the trajectory.

26. The radiofrequency communication device according to claim 16, wherein the at least one first arm comprises a reflective element situated radially outside the at least one first arm relative to the axis of rotation of the rotation system.

27. The radiofrequency communication device according to claim 26, wherein the reflective element is arranged radially outside at least the two radiofrequency antennas by a distance e.

28. The radiofrequency communication device according to claim 27, wherein the distance e is less than 0.5 times a wavelength linked to a communication frequency of the radiofrequency communication device.

29. The radiofrequency communication device according to claim 16, wherein the radiofrequency communication device further comprises at least one other first arm positioned in an identical radial position and a different azimuthal position with respect to the at least one first arm relative to the axis of rotation of the rotation system.

30. The radiofrequency communication device according to claim 29, wherein the first arms are evenly distributed about the axis of rotation.

31. The radiofrequency communication device according to claim 29, wherein, each at least one other first arm comprising at least two radiofrequency antennas, the two radiofrequency antennas of each at least one other first arm are situated at different heights with respect to heights of the at least two radiofrequency antennas of the at least one first arm.

32. The radiofrequency communication device according to claim 29, wherein the radiofrequency communication device comprises two first arms situated diametrically opposite each other relative to the axis of rotation of the rotation system.

33. The radiofrequency communication device according to claim 16, wherein, each radiofrequency antenna defining, depending on an electrical power supplied, a communication area characterized by a gain defining a maximum distance Di from the communication area and a beam angle αi, a distance d′ along the first direction separating two radiofrequency antennas situated on a same side of the at least one first arm is less than a threshold A defined by the following formula:
$$A = {\sum }_{i} {D}_{i} * cos ( {α}_{i} ) .$$

34. A conveyor line suitable for conveying objects placed in a stack along a given path comprising the radiofrequency communication device according to claim 16.
